(19) United States
(12) Patent Application Publication
(10) Pub. No.: US 2025/0159405 A1
(43) Pub. Date: May 15, 2025

(54) System And Method For Driving A Transducer

(71) Applicant: SONICEDGE DK APS, Struer (DK)

(72) Inventors: Henrik Thomsen, Holte (DK); Tore Jørgensen, Frederikssund (DK); Niels Marker-Villumsen, Måløv (DK); Mordehai Margalit, Zichron Yaaqov (IL); Sagi Chen, Haifa (IL)

(21) Appl. No.: 18/945,650

(22) Filed: Nov. 13, 2024

Related U.S. Application Data
(60) Provisional application No. 63/598,612, filed on Nov. 14, 2023.
(60) Provisional application No. 63/696,885, filed on Sep. 20, 2024.

(51) Int. Cl. H04R 3/00; H04R 15/00

(52) U.S. Cl. CPC H04R 3/00; H04R 15/00; H04R 2201/003

(57) ABSTRACT

Techniques described herein generally relate to generating an audio signal with a speaker. In some examples, a speaker device is described that includes a membrane and a shutter and driver device is configured to receive an audio signal, modulate it and generate electric signals to operate the speaker and generate an acoustic audio signal.

### TECHNICAL FIELD

The present disclosure generally relates to systems and methods for generating an electronic signal to drive a transducer. In some examples the system and methods of generating the electronic signal to drive a transducer are applied in a mobile, wearable, or portable device. In other examples the system and methods of generating the electronic signal to drive a transducer are applied in earphones, headsets, hearables, or hearing aids.

### BACKGROUND OF THE DISCLOSURE

U.S. Pat. No. 8,861,752 describes a picospeaker which is a novel sound generating device and a method for sound generation. The picospeaker creates an audio signal by generating an ultrasound acoustic beam which is then actively modulated. The resulting modulated ultrasound signal has a lower acoustic frequency sideband which corresponds to the frequency difference between the frequency of the ultrasound acoustic beam and the modulation frequency. US20160360320 and U.S. Pat. No. 20,160,360321 describe MEMS architectures for realizing the picospeaker. U.S. Pat. No. 20,160,277838 describes one method of implementation of the picospeaker using MEMS processing. US2016277845 describes an alternative method of implementation of the picospeaker using MEMS processing.

US20230247357 describes an electronic driving circuit to operate the picospeaker. The electronic circuit includes a digital and analog portion. However, state of art approaches to operate the picospeaker do not provide the required performance in terms of noise, dynamic range, harmonic distortion, and latency. Furthermore, the electrical power draw of the circuitry is prohibitive for some applications. Hence it is desirable to provide an architecture and method of operating the picospeaker which resolve these issues.

### Glossary

“acoustic signal”—as used in the current disclosure means a mechanical wave traversing either a gas, liquid or solid medium with any frequency or spectrum portion between 10 Hz and 10,000,000 Hz.

“audio” or “audio spectrum” or “audio signal”—as used in the current disclosure means an acoustic signal or portion of an acoustic signal with a frequency or spectrum portion between 10 Hz and 20,000 Hz.

“speaker” or “pico speaker” or “micro speaker” or “nano speaker” or “MEMS speaker”—as used in the current disclosure means a device configured to generate an acoustic signal with at least a portion of the signal in the audio spectrum.

“membrane”—as used in the current disclosure means a flexible structure constrained by at least two points.

“blind”—as used in the current disclosure means a structure with at least one acoustic port through which an acoustic wave traverses with low loss.

“shutter” or “modulator”—as used in the current disclosure means a structure configured to move in reference to the blind and increase the acoustic loss of the acoustic port or ports.

“acoustic medium”—as used in the current disclosure means any of but not limited to; a bounded region in which a material is contained in an enclosed acoustic cavity; an unbounded region where in which a material is characterized by a speed of sound and unbounded in at least one dimension. Examples of acoustic medium include but are not limited to; air; water; ear canal; closed volume around ear; air in free space; air in tube or another acoustic channel.

### SUMMARY

Some embodiments of the present disclosure may generally relate to a speaker device that generates an audio signal by modulation of an ultrasound signal. The speaker device is connected to an electronic driver device where the electronic driver device supplies at least two electrical signals, a first signal to generate the ultrasound signal and a second signal to generate a modulation signal. The driver device receives an input audio signal from which it generates a modulated audio signal to operate the membrane and generate an ultrasonic modulated signal. The driver further operates the shutter at the modulation frequency to demodulate the ultrasonic modulated signal and generate an acoustic audio signal.

Other embodiments of the present disclosure may generally relate to a speaker device comprising an array of membranes and shutters. The array of membranes and shutters operate either independently or together driven by the driver device. In one example, the driving device is a semiconductor integrated circuit which includes; a controller; a charge pump configured to generate a high voltage signal; a switching unit configured to modulate the high voltage signal. The driving device receives a digital sound data stream and an operating voltage and outputs driving signals for the membrane, and shutter. In some embodiments the membrane and shutter operate asynchronously and or independently of each other at one or more frequencies. In other embodiments the membrane and shutter operate synchronously at the same frequency. In the synchronous mode of operation, the amplitude of the audio signal is controlled by any of but not limited to; the relative phase of the membrane and shutter operation; the amplitude of the shutter operation; the amplitude of the membrane operation; any combination of these.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are therefore not to be considered limiting of its scope, the disclosure will be described with additional specificity and detail through use of the accompanying drawings.

FIG. 1 is an example of a driver device configured to operate a speaker device;

FIG. 2 is an example of a driver device with an audio signal input and configured to generate voltage signals to drive the speaker device;

FIG. 3A is an example of the power spectral density of driver signals;

FIG. 3B and FIG. 3C are examples of simulated power spectral density of a 2 level (FIG. 3B) and 3 level (FIG. 3C) PWM signal;

FIG. 4 is an example of a digital signal flow of the driver device with a digital input;

FIG. 5 is an example of a digital signal flow of the driver device with an analog input;

FIG. 6 is an alternative example of a digital signal flow of the driver device;

FIGS. 7A, 7B, 7C, 7D, and 7E are a further example of a digital signal flow of the driver device with a digital input or analog input;

FIG. 8A, 8B, 8C are an example of measured power spectral density corresponding to the digital signal flows of FIG. 7A to 7E.

FIG. 9 is an example of the drive circuit FIG. 1 which includes one or more filters between the drive output and MEMS speaker.

FIG. 10 is an example of a single pole low pass filter for MEMS membrane drive enhancement.

FIG. 11 is an example of the spectrum of a filter from FIG. 9 compared to the spectrum of the drive signal and signal after the filter.

FIG. 12 is an example of a comparison between the voltage from the driver and the voltage after the filter.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other examples may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure. This disclosure is drawn, inter alia, to methods, apparatus, computer programs, and systems of generating an audio signal.

In some examples, a speaker device is described that includes a membrane and a shutter. The membrane is configured to oscillate along a first directional path and at a combination of frequencies with at least one frequency effective to generate an ultrasonic acoustic signal. A shutter and blind are positioned proximate to the membrane. In one non limiting example the membrane, the blind, and the shutter may be positioned in a substantially parallel orientation with respect to each other. In other examples the membrane, the blind, and the shutter may be positioned in the same plane and the acoustic signal is transmitted along acoustic channels leading from the membrane to the shutter. In a further example the modulator and or shutter are composed of more than one section.

In some embodiments, the membrane is driven by an electric signal that oscillates at a frequency Q and hence moves at b Cos (2π*Ωt), where b is the amplitude of the membrane movement, and t is time. The electric signal is further modulated by a portion that is derived from an audio signal a(t). The acoustic signal generated by the membrane is characterized as:

$$s ( t ) = b a ( t ) Cos ( 2 π Ω t ) \qquad ( 1 )$$

Applying a Fourier transform to Equation (1) results in a frequency domain representation

$$S ( f ) = b / 2 * [ A ( f - Ω ) + A ( f + Ω ) ] \qquad ( 2 )$$

Where A(f) is the spectrum of the audio signal. Equation (2) describes a modulated audio signal with an upper and lower side band around a carrier frequency of Ω (Double Side Band-DSB). Applying to the acoustic signal of Equation (1) an acoustic modulator operating at frequency Ω results in

$$S ( t ) = b a ( t ) Cos ( 2 π Ω t ) ( l + m Cos ( 2 π Ω t ) ) \qquad ( 3 )$$

Where l is the loss of the modulator and m is the modulation function and due to energy conservation l+m<1. In the frequency domain

$${S}^{′} ( f ) = b / 4 [ m A ( f ) + m A ( f + 2 Ω ) + A ( f - Ω ) + A ( f + Ω ) ] \qquad ( 4 )$$

Where b/4 m A(f) is an audio signal. The remaining terms are ultrasound signals where m A(f+2Ω) is at twice the modulation frequency and A(f−Ω)+A(f+Ω) is the original unmodulated signal. Additional acoustic signals may be present due to any but not limited to the following; ultrasound signal from the shutter movement; intermodulation signals due to nonlinearities of the acoustic medium; intermodulation signals due to other sources of nonlinearities including electronic and mechanical.

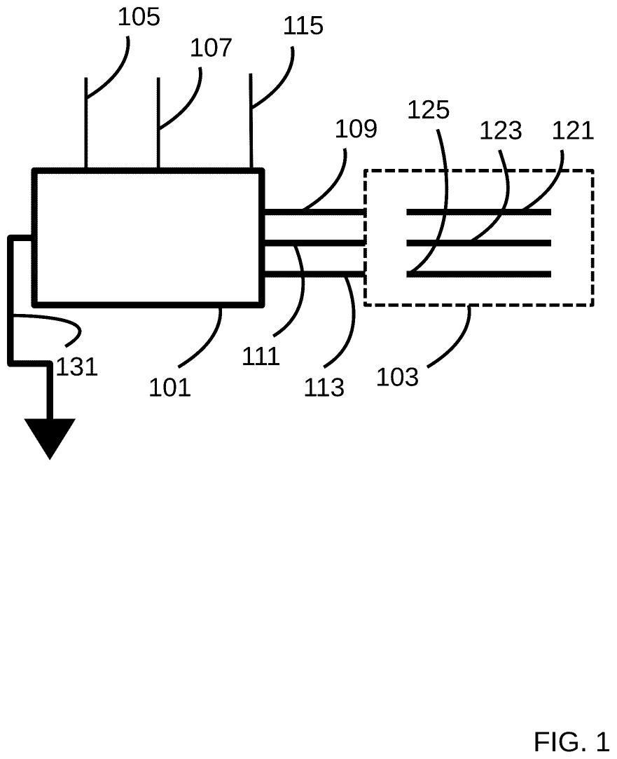

FIG. 1 is an example of a driver device (101) configured to operate a speaker device (103). In one example the driver device (101) generates two electrical signals. A first signal corresponding to equation (1) a(t) Cos (2πΩt+@), and a second signal corresponding to the modulator signal as appears in equation (3) Cos (2πΩt+Θ). Where Φ and Θ are constant or time varying phases. In one example Φ and Θ are equal and constant. In a further example, a driver device (101) is configured with at least two inputs; a first input (105) providing an electrical audio signal and a second input (107) providing electrical power. In one example the electrical audio signal is an analog signal, and the driver device samples and converts the analog signal to a digital pulse code modulation (PCM) or pulse density modulation (PDM) signal. In an alternative example the input signal is a PCM signal. In a further example the PCM signal is provided using a standard protocol such as 12S at a sampling rate Fr, where Fr is any of but not limited to; equal to or less than 44.1K, 48K, 96 K or higher, 768 KHz or higher. In one example the first input (105) comprises of one analog input electrical line. In an alternative example, the first input (105) comprises of at least two digital input lines; a data signal and a clock signal. In a further example the first input comprises of at least three digital input lines; a data signal; a clock signal; and a control signal. In a further example a control signal includes but is not limited to; identification information; left right designation. The driver device (101) is configured with at least three connections to the speaker device (103). A first connection (109) provides the electrical signal to the shutter (121), a second connection (113) provides the electrical signal to the membrane (125) and a third connection (111) provides the electrical signal to the blind (123). In a further example, the third connection is connected to the ground line of the device driver (101). In a further example the device driver (101) includes one or more additional electrical connection (131) to the common ground of the electrical circuit. In a further example, the device driver (101) is assembled in a printed circuit board (PCB) which further includes; capacitors; battery unit; power unit; audio codec; blue tooth unit; microphones; clock generator unit; inertial sensors; optical sensors.

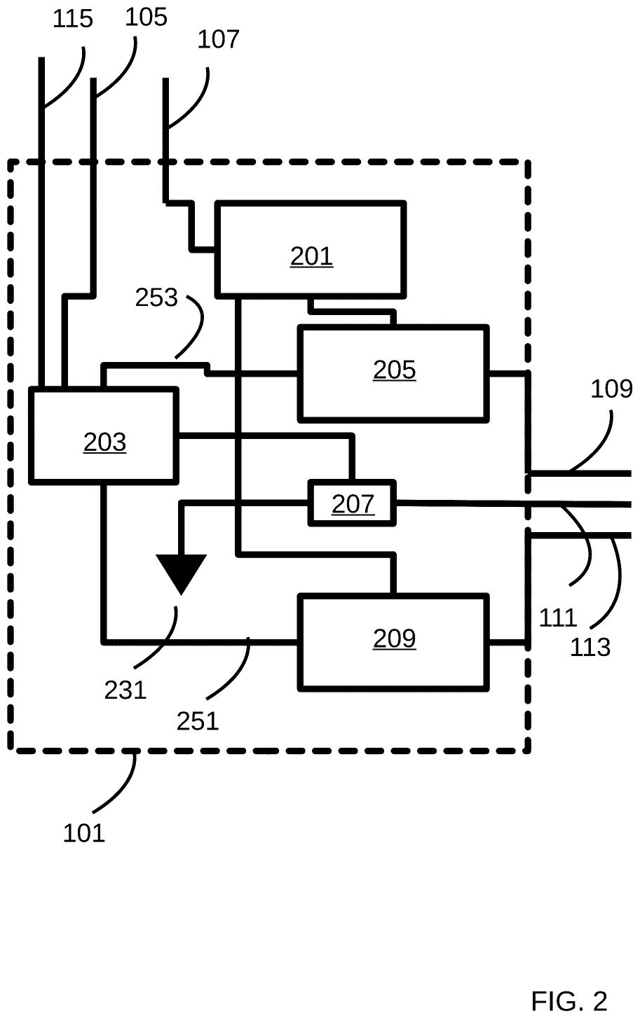

FIG. 2 is an example of a driver device (101) with an audio signal input and configured to generate voltage signals to drive the speaker device. In one example a driver device (101) includes but is not limited to; a charge pump (201); controller (203); MEMS drivers (205, 209); current detection unit (207). In a further example, one MEMS driver (205) is configured to drive the modulator and a second MEMS driver (209) is configured to drive the membrane. In a further example the modulator signal is a sine wave or square wave or triangular or any other periodic signal with a time period of 1/(mechanical resonance frequency). The principal component is the first harmonic component corresponding to the resonance frequency of the modulator membrane(s). In an alternative example the modulator and membrane signal are modulated ultrasound signals. The audio output is a multiplication of the modulation signal (o(t)) of the membrane and modulation signal (p(t)) of the modulator. In a further example the two modulation signals contain non overlapping spectral components. In a further example one modulation signal has a band limited spectrum with a first and second frequency limit, and the second modulation signal has a band limited spectrum with a band limited spectrum with a third and fourth frequency limit. Examples of first, second, third and fourth frequencies represented as {1^{st}, 2^{nd}, 3^{rd}, 4^{th}} limits include but are not limited to, {0.10 Hz, 10 Hz, greater than 20 KHz}; {0,100 Hz, 100 Hz, greater than 20 KHz}, a second frequency between 10 to 200 Hz, a third frequency greater than a second frequency. In an alternative example the multiplication of the modulation signals corresponds to the audio signal (a(t)) so that a(t)=o(t) p(t). In a further example a spectral filter or equalizer (h(t)) is included in one or the modulation signals or in the signal chain so that a (t)={o(t) p(t)}*h(t) where * is the convolution operator. The driver device (101) receives input power from an external power unit. Examples of operating voltages include but are not limited to; 1Volt; 1.7 Volt; 3-4 Volt; 3.6 Volt; 4-5 Volt. The required voltages for operating the driver device are derived from the input power and the high voltage for operating the speaker device is generated by the charge-pump or step-up convertor or other DC to DC convertor (201). In a further example the charge pump generates any off but not limited to the following voltages; 10 Volts; 20 Volts; 20-30 Volts; 30-40 Volts; higher than 40 Volts. Examples of charge-pump (201) architectures include but are not limited to; Single-ended charge pump architectures; Fully differential charge pump architectures; Charge pump voltage doubler architectures; Charge pump with current steering techniques. In an alternative example the required voltages are supplied externally to the driver device. In an alternative example, one or more external capacitor and or inductors are used to store and or generate the required voltages for the step-up convertor or charge pump (201). In one example, the MEMS speaker drivers (205, 209) are configured as a switch with one state where the voltage supplied by the charge pump is connected to the respective speaker device membrane or modulator. The speaker device membrane or modulator is primarily a capacitor. In an alternative example, the MEMS speaker drivers (205, 209) are configured as a multilevel switch where two or more voltages derived from the charge pump (201) or intermediate stages of the charge pump (201) are alternatively connected to the relevant membrane or modulator driver (205. 209). By using two or more voltage levels, the maximum voltage discharge of the speaker device membrane or modulator is reduced by N where N is the number of voltage levels. In a further example the MEMS speaker driver include a filter to reduce or enhance the electrical drive signal at designated frequencies. In one example the filter is any of but not limited to; a low pass filter with a cutoff frequency at half the resonance frequency, a low pass filter with a cutoff frequency at the resonance frequency, a band pass filter with a center frequency corresponding to the resonance frequency and a bandwidth greater than 20 KHz. The controller (203) receives the input audio signal and generates the control signals for the membrane and modulator driver. In one example, the input audio signal is an analog electrical signal, and the controller (203) includes an analog to digital conversion unit (ADC). In an alternative example the input audio signal is a digital electrical signal. Examples of digital signals include but are not limited to I2S, PCM, PDM, SLIMbus or PWM. The controller (203) generates electrical signals to operate the MEMS drivers (205, 209). Lines (251, 253) provide the control signal for the MEMS driver (205, 209). In one example the MEMS modulator driver (205 or 209) is driven by a binary pulse train with a repetition frequency corresponding to the mechanical resonance frequency of the modulator. In a further example, the MEMS modulator is driven by two or more signals corresponding to a multiplicity of voltage levels. In a further example, the MEMS modulator voltage level or amplitude is switched at a frequency lower than any off but not limited to; lower than 500 Hz, lower than 200 Hz, lower than 100 Hz, lower than 10 Hz. The role of the low frequency switching is to operate the MEMS modulator at one voltage level corresponding to the slowly changing average volume of the sound, in order to reduce average power consumption. In a further example the controller (203) includes a clock input (115) to receive an external stable clock signal for controller operation timing. Examples of clock frequencies include but are not limited to 800 MHZ-1 GHz; 600-800 MHz; 400-600 MHz; 200-400 MHz; 50-200 MHz; up to 100 MHz. In an alternative example, the clock signal (115) is derived from the data signal as described below. In a further example when using an analog audio input signal, the clock signal (115) is the system clock. In an alternative further example, when the audio input signal is digital then the clock signal (115) may be the clock signal associated with the digital signal, for example CLK line in 12S, bit clock signal, frame clock signal, the data signal or any other related clock signal. The internal clock generated by the CLK block is configured to be close to a multiple of the mechanical resonance frequency. In an alternative example the drive signals are combined into a single drive signal operating a single membrane which combines both membrane and modulator functionality.

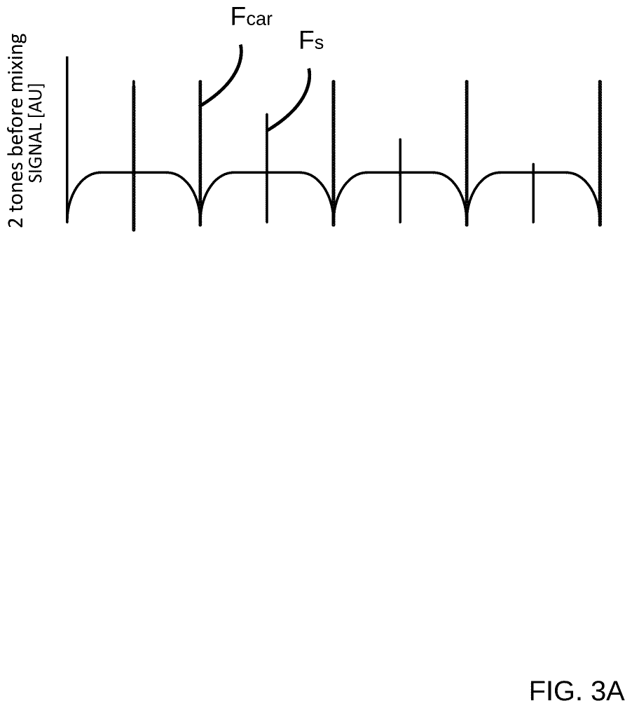

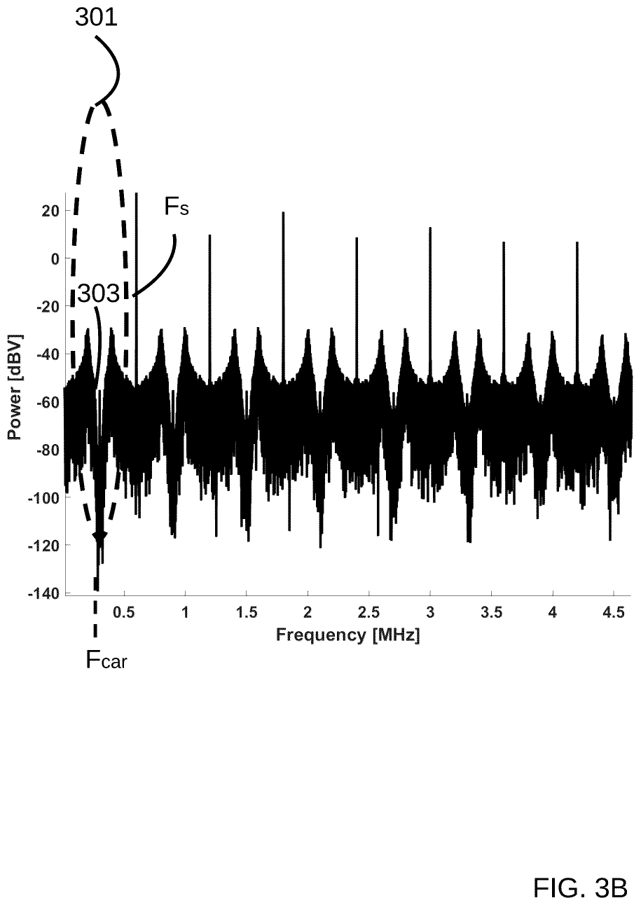

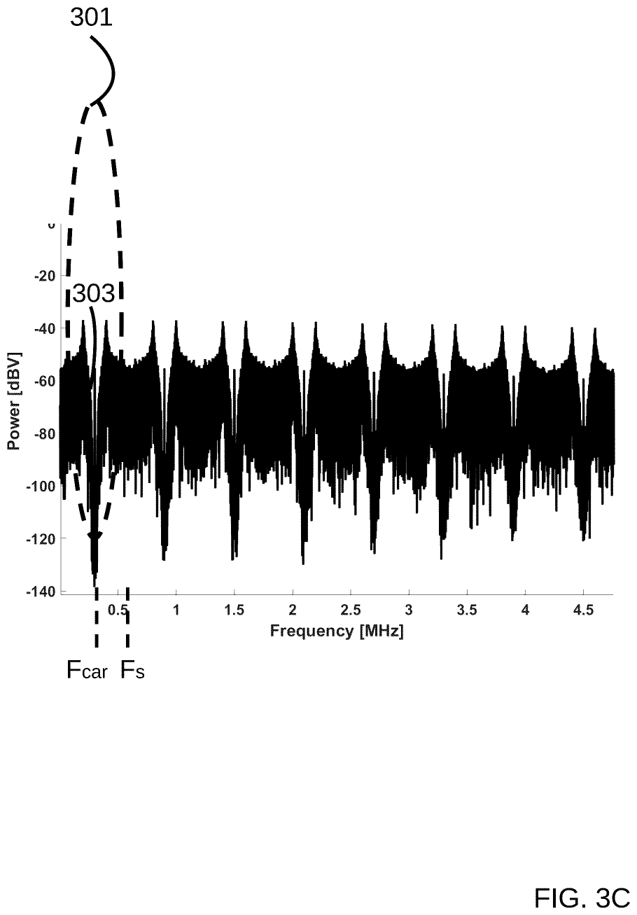

FIG. 3A is an example of the power spectral density of driver signals. The two graphs correspond to the N bit noise shaped signal before and after modulation. In one example the sampling frequency Fₛ is chosen to be at least twice the carrier frequency F_{car}. This is required by Nyquist principle to minimize aliasing when sampling the signals. It should be noted that the input audio signal may be sampled at a different frequency and method for converting the sampling rate should be included in the signal flow. In an alternative example shown in FIG. 3, the sampling frequency Fₛ is chosen to be exactly twice the carrier frequency F_{car}. This choice provides several advantages; minimizing aliasing when mixing up; simplifying noise shaper filter; simplify mixer implementation; enabling direct drive of carrier. When considering the action of mixing or modulation we need to consider not only the area of interest around the signal but also the noise at other frequencies. One of the concerns is that the mixing or modulation action will transfer noise from higher frequencies into the frequency band of interest. For example, if the frequency band of interest is 280 KHz to 320 KHz, then noise at 560 KHz to 640 KHz, might be mixed down in the same way that the signal at 310 KHz is mixed down to 10 KHz. Hence it is desirable that the noise and any nonlinear signals be minimized in the multiples of the frequency band of interest. As evident in FIG. 3, the choice of Fₛ=2*F_{car}, enables a digital architecture which ensures this aspect. Further this enables design of the noise shaping filter to be a low pass rather than bandpass filter. This reduces the order of the filter by 2, and thus reduces complexity of implementation, power and time required to execute the noise shaping filter. The mixer is also simplified since the mixing function is now just a multiplication by 1 or −1 which is a single bit flip for sign magnitude representation and one's complement, and sign inversion for twos complement representation. Hence further minimizing power and complexity, and finally the modulation signal is a binary signal which can be used directly to switch the driver for the modulator or shutter membrane (FIG. 1 121) in the MEMS speaker. In a further example F_{car} is chosen as an integer multiple of the audio frequency. In a further example to avoid the need for a sample rate conversion F_{car} is any of but not limited to 96 KHz; 196 KHz; 384 KHz; 768 KHz. In a further example to avoid the need for a sample rate conversion but potentially use a decimation filter F_{car} is integer division (M) of the bit rate with bit rates any of but not limited to 196*16 (bit) KHz; 196*24 (bit) KHz; 196*32 (bit) KHz; 384*16 (bit) KHz; 384*24 (bit) KHz; 384*32 (bit) KHz; 768*16 (bit) KHz; and M is 2; 4; 6; 8; 10; larger than 2.

FIG. 3B and FIG. 3C are examples of simulated power spectral density of a 2 level (FIG. 3B) and 3 level (FIG. 3C) PWM signal. Modulated audio band (301) is the reduced noise spectral region due to the sigma delta modulator transfer function. Modulation signal (303) is a consequence of the 2-level modulation scheme. Modulation signal (303) draws power according to P=C f V² where P is power, C is device capacitance, V is the drive voltage and f is the frequency of the modulation signal (303). Eliminating modulation signal (303) would reduce operating power and can be achieved with a 3 level PWM drive as demonstrated in FIG. 3C.

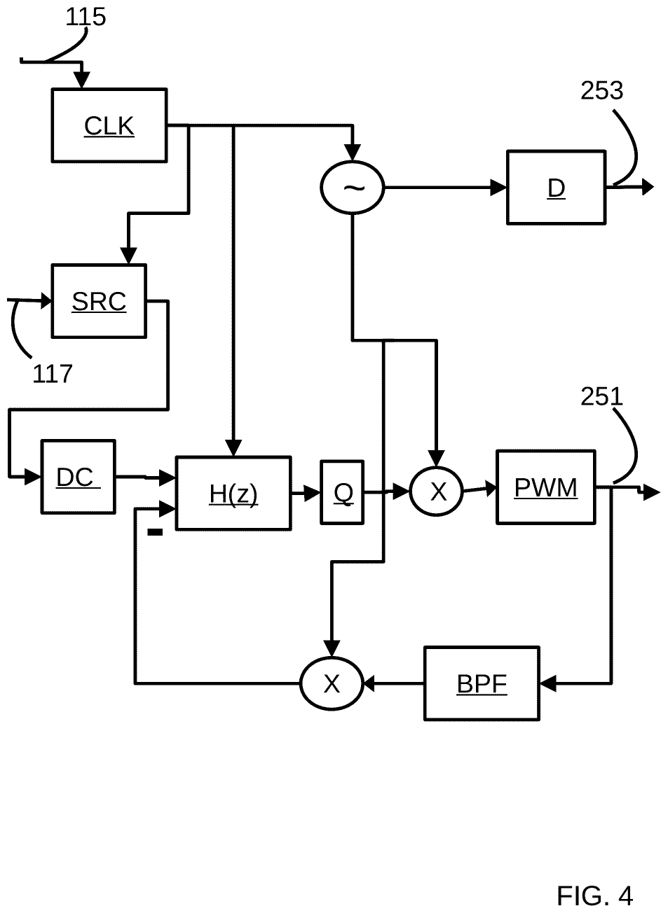

FIG. 4 is an example of a digital signal flow of the driver device with a digital input signal. FIG. 4 does not include the MEMS driver (FIG. 2 205, 209), and lines (251, 253) provide the control signal for the MEMS driver (FIG. 2 205, 209). The digital signal flow includes at least but not limited to the following elements or units; a sample rate converter (SRC), a system clock (CLK), a low pass filter (LPF), a delay unit (D), a pulse width modulation unit (PWM). a DC block unit (DC) unit configured with a high pass filter with a low cutoff, (for example below 20 Hz) to removes slow varying DC biases from the audio signal. The DC block unit (DC) further includes a unit to add or subtract a system defined signal to the high pass filtered audio signal. The system defined signal is configured to move an idle signal pattern generated in the sigma delta modulator out of the relevant audio band and thus reduce the noise level and enhance SNR. In a further example, the system defined signal is generated and added to the high pass filtered audio signal when the level of the input signal is low. In an alternative further example, the system defined signal is a slow time varying signal. In an alternative further example, the system defined signal is a predefined constant signal. The filter unit (H(z)) is configured as the transfer function that defines the noise transfer function (NTF) and signal transfer function (STF) of the sigma delta modulator (SDM) implemented by the combination of the filter unit (H(z)), a quantizer (Q) which outputs a quantized signal with N levels. Examples of the filter unit (H(z)) may include but are not limited to; a CIFF structure; CIFB structure; other lowpass modulator filter structure. In a further example the filter unit is of an order of at least but not limited to 3; 4; 5; 6; 7; 8; 9; 10; 11; 12. In a further example the quantizer (Q) generates a signal with a finite number of bits (N). In a further example for a three level PWM signal N is any of but not limited to; 51-101; 101-201; 301-501; or combinations of these and for a two level PWM N is any of but not limited to 51-101; 101-201 for two level PWM. In an alternative example N is 257 for a three level PWM and 129 for a two level PWM.

The signal flow is any of but not limited to; an external clock signal (115) is used by the system clock (CLK) to generate the synchronization signal for all signal processing tasks. The frequency of system clock (CLK) is determined at least by the clock requirements of the sample rate converter. In one non limiting example the system clock (CLK) is implemented as a Fractional-N PLL or integer PLL, or other PLL architectures. and designed to operate at frequencies including but not limited to; above 10 MHz, above 20 MHz, above 50 MHz, above 100 MHZ. In an alternative example the provided system clock (CLK) frequency is an integer multiple of the mechanical resonance frequency, e.g. 128*f-resonance. The sample rate converter (SCR) receives a digital input signal (117) and a system clock (CLK) signal. The input signal (117) is a digital signal. In one example the signal is any of but not limited to; serial single bit signal such as I2S; PDM; proprietary protocol; SLIMbus or a parallel, multibit signal. The input signal sampling rate is any of but not limited to 44.1 KHz, 48 KHz, 96 KHz, 192 KHz, 384 KHz, 768 KHz. The input signal is any of but not limited to a 16 bit, 24 bit or 32-bit signal. Hence the raw signal rate is between 44.1 KHz×16 bit to 768 KHz×32 bit, or between 705 KHz and 24.576 MHz. If the input signal is a noise shaped binary sequence, the input frequency is between 1.5 MHz to 25 MHz and the sample rate converter provides a multibit signal for the sigma delta modulator implementation. The filter unit (H(z)) low pass sigma delta receives a multi bit signal and delivers a noise shaped N bit signal where 2^{N} is the number of discrete levels in the PWM. The noise shaping reduces the in-band noise; where the band of interest is any of but not limited to 5 KHz, 10 KHz, 20 KHz, 45 KHz. The system clock (CLK) is used to derive the carrier frequency (F_{car}) bit sequence (˜). In a further example the carrier frequency (F_{car}) is equal or up to 20 KHz higher or up to 20 KHz lower than the mechanical resonance frequency of the MEMS modulator. Due to the choice of Fₛ=2 F_{car} the multiplication is implemented by flipping the sign bit in the signal representation for sign magnitude representation and one's complement, and sign inversion for twos complement representation. The noise shaped; N bits are used to operate the pulse width modulation (PWM) which outputs a pulse with 2^{N} width values. The pulse may be located at the start of the timing unit, in the middle of the timing unit and at the end of a timing unit. The pulse width modulation is a non-linear transformation of the input signal. In a further example, to enhance the signal reproduction and reduce the nonlinear portion in the output signal a feedback path is included. The feedback path includes a band pass filter (BPF) where the band pass filter (BPF) reduces the out of band frequency components of the feedback signal. The feedback signal is then modulated or mixed by the carrier signal frequency F_{car} and introduced into the filter unit (H(z)) as feedback. In a further example the feedback signal is subtracted from the input signal from the sample rate convertor (SRC). The PWM signal (123) is used a drive signal for the high voltage switch (FIG. 2 209). The carrier bit signal is delayed in delay block (D) so that the phase output of modulator (121) and PWM signal (123) is any of but not limited to 0°, 45°, 90°, 120°. Modulator output (121) is used to drive the high voltage switch of modulator (FIG. 2. 205).

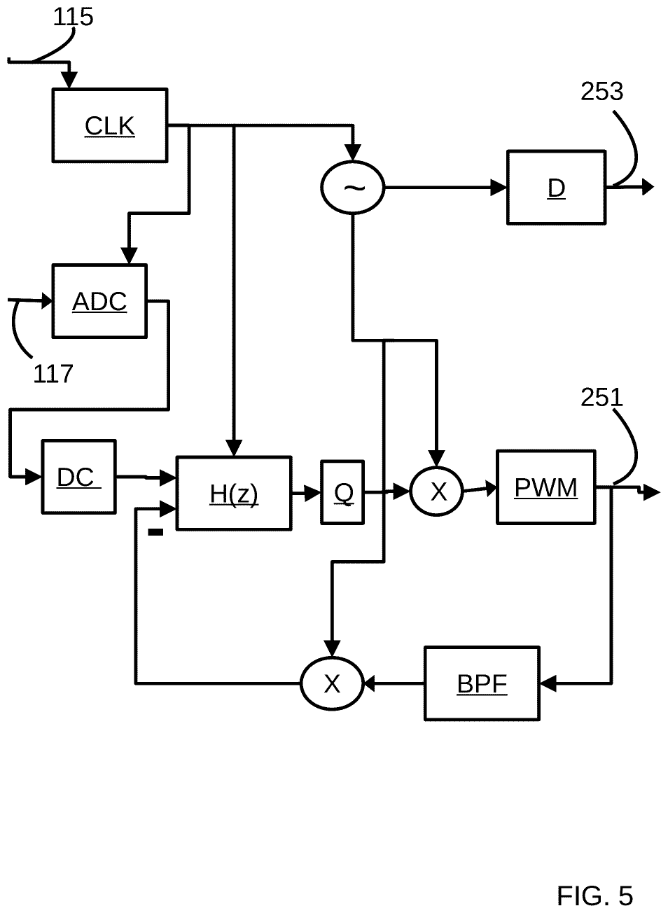

FIG. 5 is an example of a digital signal flow of the driver device with an analog input signal. FIG. 5 does not include the MEMS driver (FIG. 2 205, 209), and lines (251, 253) provide the control signal for the MEMS driver (FIG. 2 205, 209). In this example the sample rate conversion (FIG. 4 SRC) is replaced with an analog to digital convertor (ADC). The ADC has an analog input signal and an output with a bit value corresponding to the analog input. In one non limiting example the analog input is between 0 and Vin where Vin is any of but not limited to less than 1 V; less than 1.17V; less than 3 Volt; less than 5 Volt; less than 12 Volt. Analog to digital converters (ADC) may be implemented in any of standard techniques including sigma delta convertor; resistor bank; capacitor bank. The sampling frequency of the ADC is chosen as Fₛ or integer multiples of Fₛ.

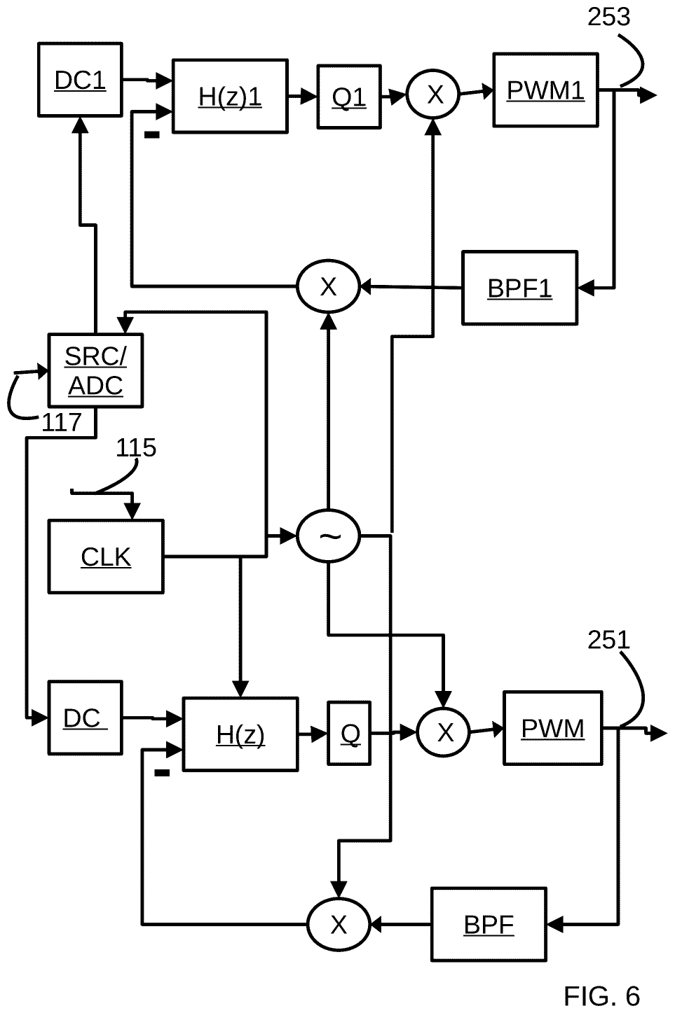

FIG. 6 is an alternative example of a digital signal flow of the driver device with either an analog input signal into an ADC or a digital signal into a SRC where for coherence both units are depicted as one unit but as described previously are implemented using different units which are combined in the device driver (FIG. 2). FIG. 6 does not include the MEMS driver (FIG. 2 205, 209), and lines (251, 253) provide the control signal for the MEMS driver (FIG. 2 205, 209). In this example the input signal after being adapted to the operating sampling frequency in either the SCR or ADC. In a further example, the adapted input signal is separated into two parts as described previously where one part is used as an input for a modified sigma delta modulator as previously described which provides a PWM control signal to drive the modulator (121) and the second part is used as an input for a modified sigma delta modulator as previously described which provides a PWM control signal to drive the membrane (123). Examples of separation include but are not limited to non-overlapping spectral components. An alternative example is where one modulation signal has a band limited spectrum with a first and second frequency limit, and the second modulation signal has a band limited spectrum with a band limited spectrum with a third and fourth frequency limit. Examples of first, second, third and fourth frequencies represented as {1^{st}, 2^{nd}, 3^{rd}, 4^{th}} limits include but are not limited to, {0.10 Hz, 10 Hz, greater than 20 KHz}; {0,100 Hz, 100 Hz, greater than 20 KHz}, a second frequency between 10 to 200 Hz, a third frequency greater than a second frequency. In an alternative example the multiplication of the modulation signals corresponds to the audio signal (a(t)) so that a(t)=o(t) p(t). In a further example a spectral filter or equalizer (h(t)) is included in one or the modulation signals or in the signal chain so that a(t)={o(t) p(t)}*h (t) where * is the convolution operator.

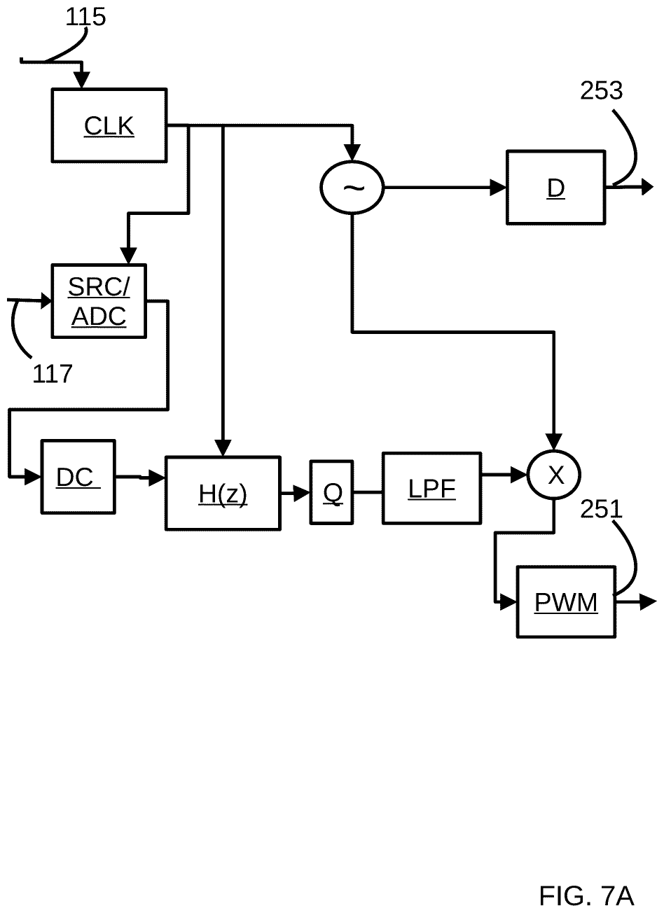

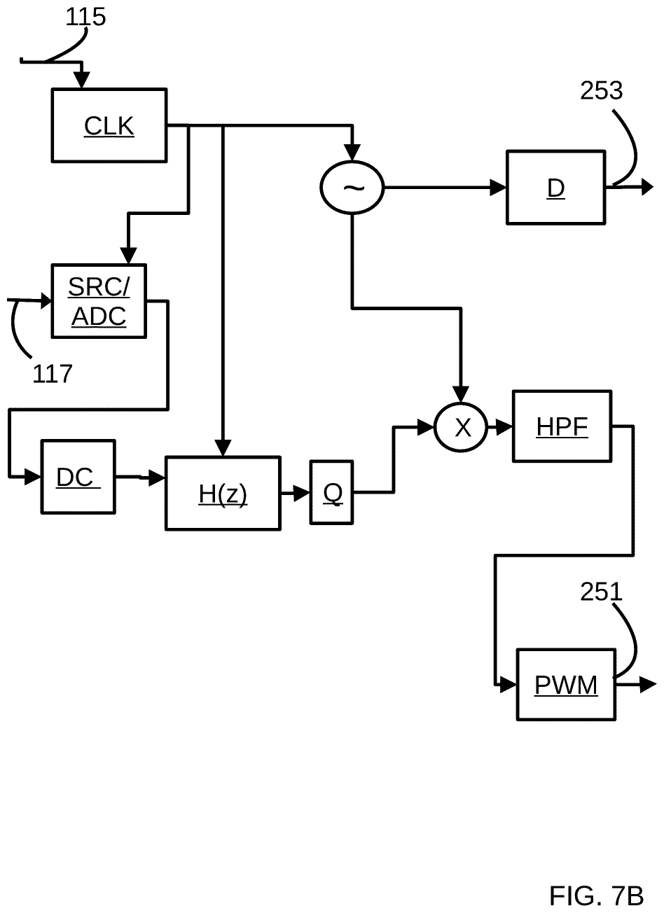

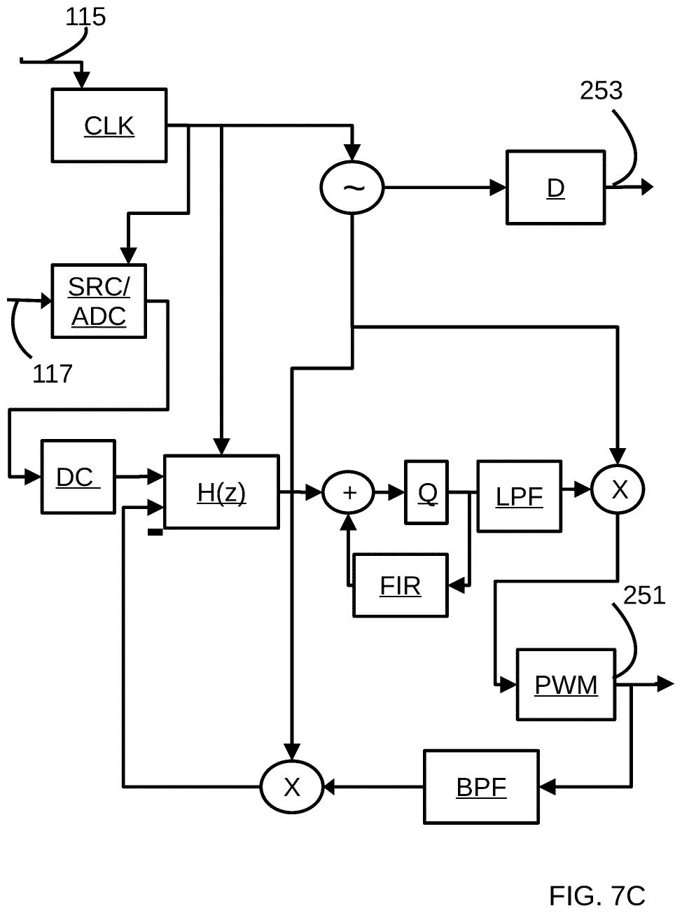

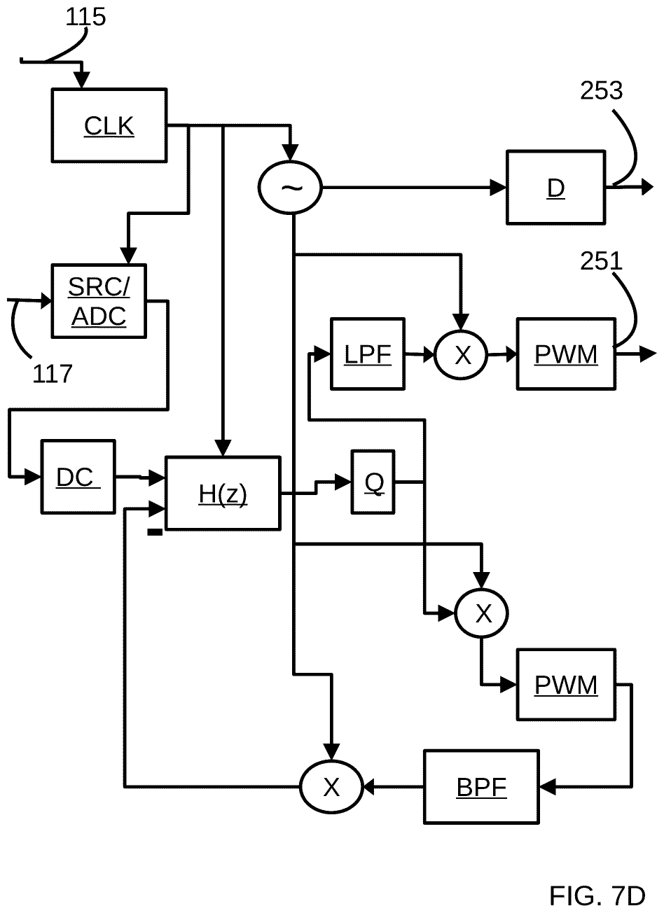

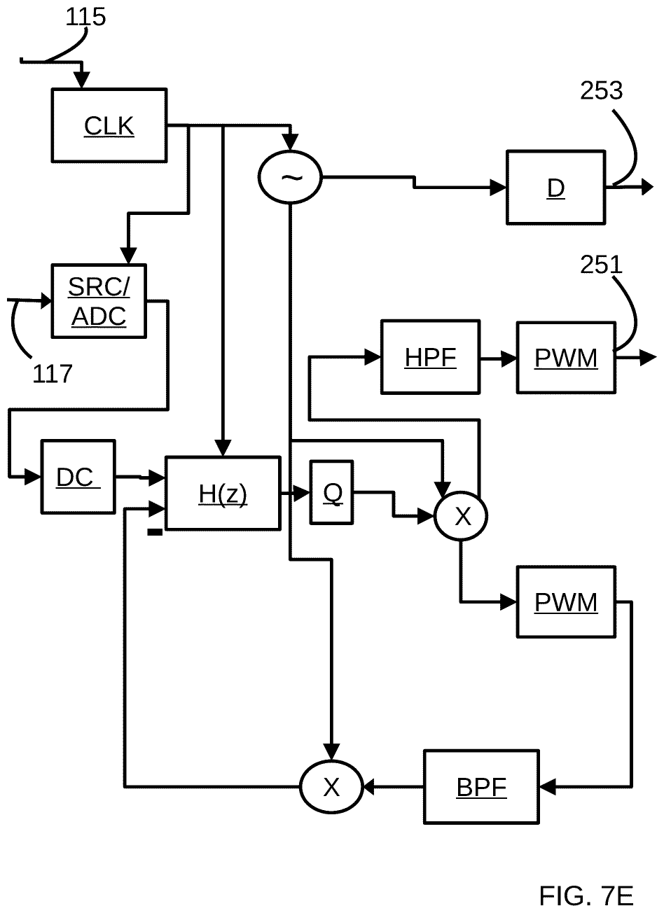

In a further example the noise floor at audio frequencies is limited by the spectral density of the noise around the Fₛ signal as shown in FIG. 3B. In one example this issue is addressed by including a filter in the digital signal path. FIGS. 7A, 7B and 7C are a further example of a digital signal flow of the driver device with a digital input or analog input and a digital filter to address the noise around Fs. In the example of FIG. 7A the filter (LPF) is a low pass filter located before the mixer (denoted by X). In one example the low pass filter is a finite impulse response filter (FIR). In a further example the FIR filter includes at least one zero corresponding to Fs/2. In an alternative further example, the FIR filter has at least but not limited to any of; greater than 20 dB, greater than 40 dB, greater than 60 dB, attenuation between Fs/2 to Fs. In a further example the FIR filter has any off but not limited to; minimum phase; constant phase; linear phase. Examples of FIR filters include but are not limited to a filter with a single set of zeros at Fs/2 [½ ½]; a double set of zeros [¼ 2/4 ¼]; a triple set of zeros [⅛ ⅜ ⅜ ⅛] or N zeros. In the example of FIG. 7B the filter is a high pass filter (HPF) which is located after the mixer (denoted by X). In one example the high pass filter is a finite impulse response filter (FIR). In an alternative further example, the FIR filter has at least but not limited to any of; greater than 20 dB, greater than 40 dB, greater than 60 dB attenuation between 0 to Fs/2. In a further example the FIR filter has any off but not limited to; minimum phase; constant phase; linear phase. Examples of FIR filters include but are not limited to a filter with a single set of zero's at 0 to 20 KHz or 40 KHz [½−½]; a double set of zeros [¼− 2/4 ¼]; a triple set of zeros [⅛−⅜ ⅜−1/g] or N zeros. In FIG. 7A and FIG. 7B the PWM feedback loop from PWM block to SDM filter block H(f) which has been used in previous examples has been omitted. In a further example the feedback loop is designed to accommodate the inclusion of the low pass filter or high pass filter since these are part of the feedback loop. FIG. 7C is an alternative example where the feedback loop from PWM to H(f) remains as described before, but to maintain stability of the PWM feedback loop an additional feedback block including at least an additional FIR filter is connected between the output of the quantizer block (Q) and summed with the input of the quantizer block (Q). The feedback loop around the quantizer is used for compensating the additional delay introduced by the FIR filter in either the 7A or 7B implementation as required for the feedback loop to be stable. In a further example the order of the FIR filter is n=1. FIG. 7D is an alternative example where the Low Pass Filter (LPF) is introduced outside the PWM loop. In this example, quantizer output provides the input to the PWM and the PWM output is fed back to the sigma delta filter H(f). The quantizer output in parallel is fed to the Low Pass Filter, which is then multiplied by the modulation signal at Fs/2 and provided as input to a second PWM. In this manner the output (251) corresponds to the PWM signal but without the impediments of the LPF as part of the PWM feedback loop. FIG. 7E is an alternative example where instead of a LPF we use a high pass filter (HPF) after the multiplication and again the parallel PWM enable to have the HPF outside the PWM feedback loop.

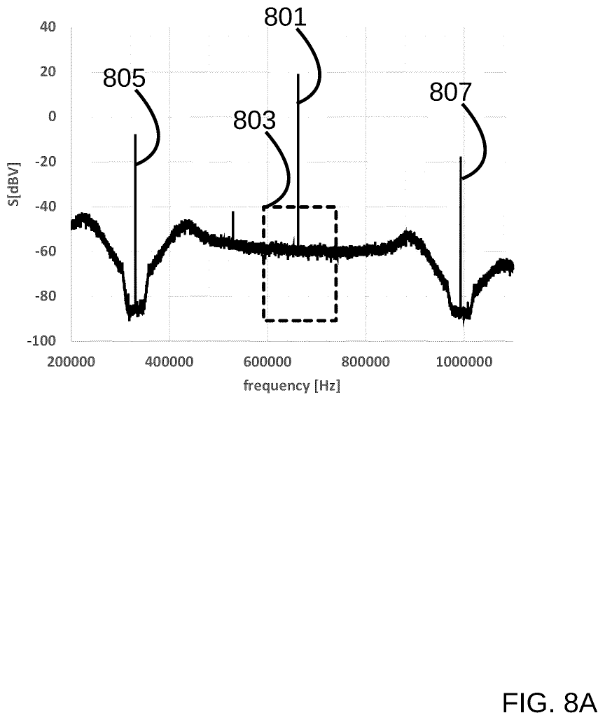

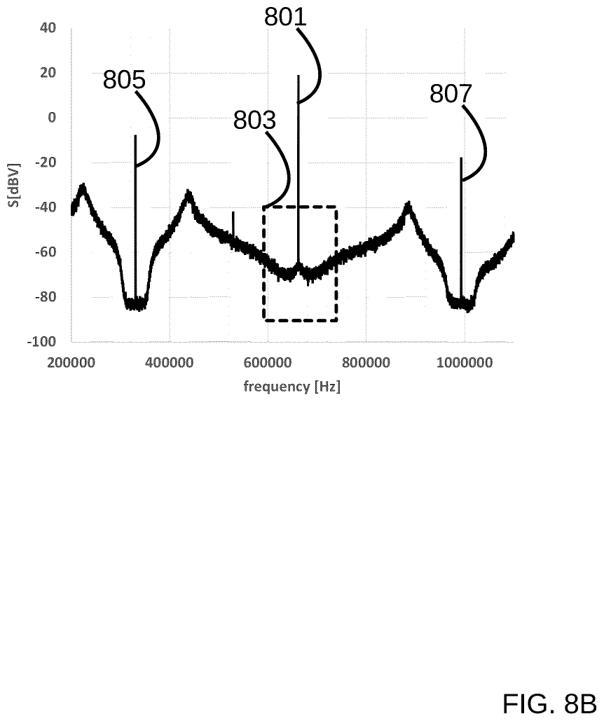

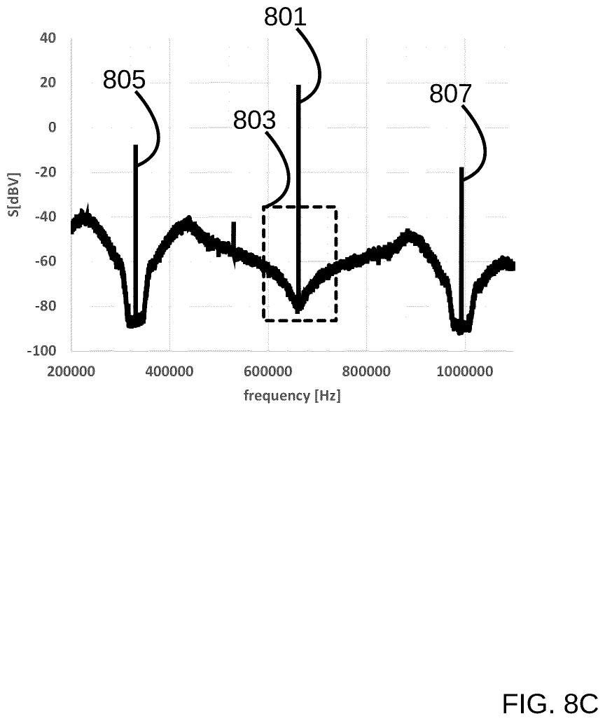

FIG. 8A is an example of measured power spectral density corresponding to the digital signal flow of FIG. 5 and exhibiting noise (in dashed box 803) around Fs (801). This noise will be done converted by the modulator signal at Fs (801) and will decrease the audio SNR. Signal (805) corresponds to the modulated ultrasound signal which is the desired output from the PWM (FIG. 7 251). FIG. 8B is an example of measured power spectral density corresponding to the digital signal flow of FIG. 7C and exhibiting reduced noise (in dashed box 803) around Fs (801) resulting in better audio SNR than FIG. 8A. FIG. 8C is an example of measured power spectral density corresponding to the digital signal flow of FIG. 7D or 7E and exhibiting further reduced noise (in dashed box 803) around Fs (801) resulting in better audio SNR than FIG. 8B.

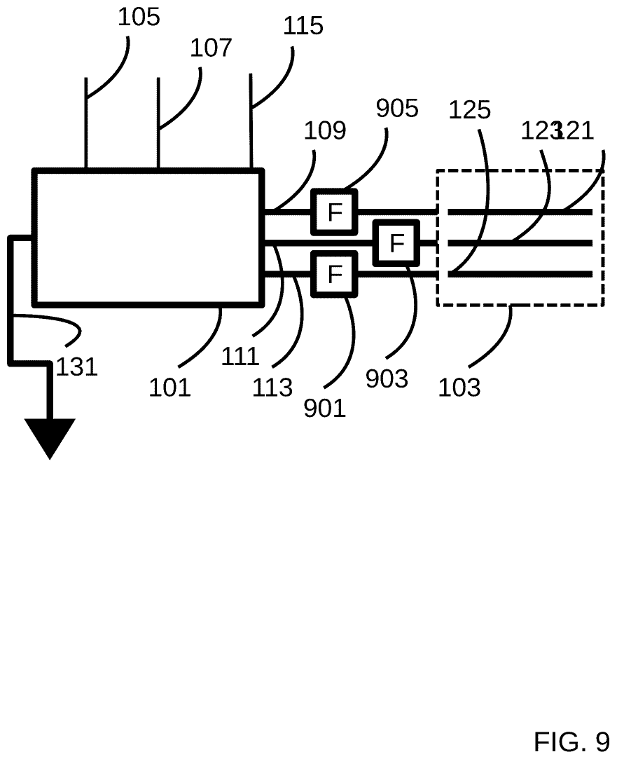

FIG. 9 is an example of the drive circuit FIG. 1 which includes one or more filters between the drive output and MEMS speaker. In a further example adding a filter between MEMS and ASIC (F, 901, 903, 905) or in an alternative example the filter is part of the ASIC Driver, or in another alternative example the filter can be partly implemented in the ASIC and externally. A filter may be implemented on any or all of the electrical connection between ASIC driver and MEMS speaker (109, 111, 113). In one example a filter is designed to enhance the performance of the MEMS speaker in one or more but not limited to; reducing noise, by reducing harmonics and out of band noise which would be down converted in the MEMS action; reducing THD by reducing harmonics of the drive signals which could downfold to harmonics in the band of interest in the MEMS; reducing rise and or fall time matching by adding a common dominating impedance on the output, any difference in driver impedance e.g. driving high vs driving low will be reduced as the impedance which differs is now only a fraction of the total output impedance. Reducing mismatch in rise and or fall time will reduce THD and noise of the MEMS speaker and enhance performance of the drive signal; reduce power, by increasing the impedance seen by the driver at the switch frequency, current out to the MEMS will be reduced and thereby power will decrease. Furthermore, filter action averages the oversampled drive signal which reduces the effective voltage swing of the MEMS capacitor for small signals, further reducing the power.

Since a MEMS membrane has a capacitance Cₘₑₘₛ, all that is needed to implement a low pass filter is an addition of resistor Rₚₐₛ in ASIC, electrical connection, MEMS package or MEMS.

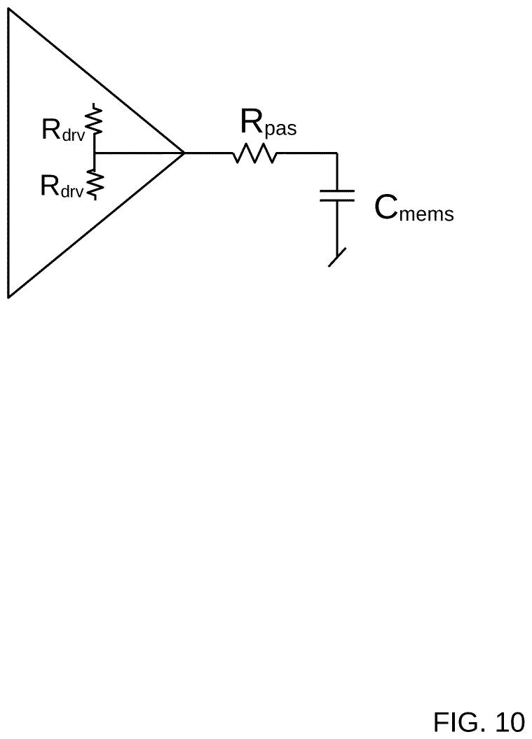

FIG. 10 is an example of a single pole low pass filter for MEMS membrane drive enhancement (FIG. 9 901, 903, 905) using the mems membrane capacitance.

The voltage of the MEMS Vₘ can now be described as:

$$\vert {V}_{m} \vert = \vert \frac{1}{1 + s {C}_{mems} ( {R}_{pas} + {R}_{drv} )} * {V}_{drv} \vert = \frac{\vert {V}_{d r v} \vert}{\sqrt{1 - {ω}^{2} {{C}_{mems}^{2} ( {R}_{pas} + {R}_{drv} )}^{2}}}$$

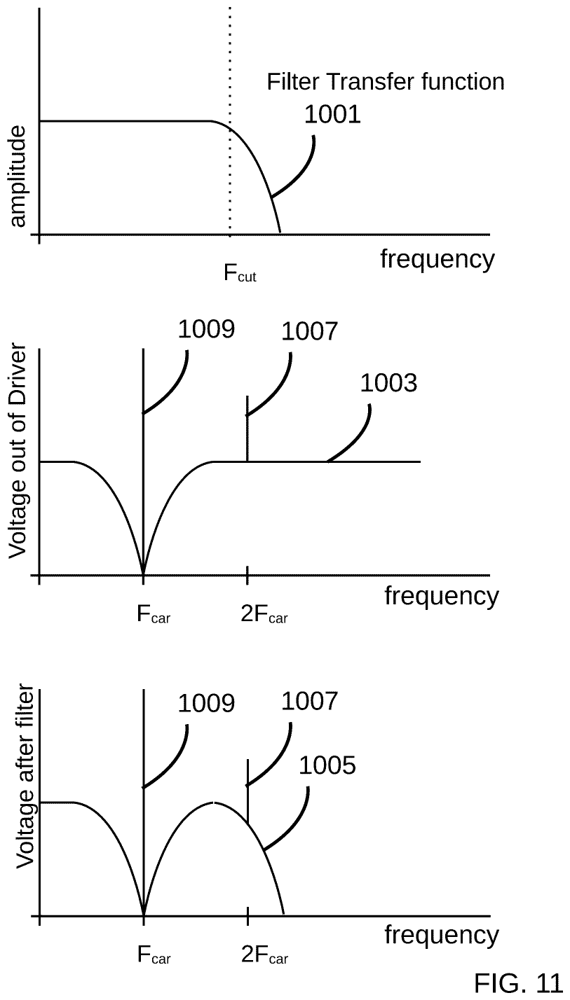

FIG. 11 is an example of the spectrum of a filter (1001) from FIG. 9 compared to the spectrum of the drive signal (1003) and spectrum of the signal after the filter (1005) where the resistor is chosen so the cutoff frequency f_{cut} is equal to or smaller than f_{cut}˜2*f_{car}(1009) providing any of but not limited to; out of band Noise and harmonics above f_{cut} are attenuated; power consumption is reduced where in a further example the PWM modulation frequency f_{mod} (1007) is twice the carrier frequency.

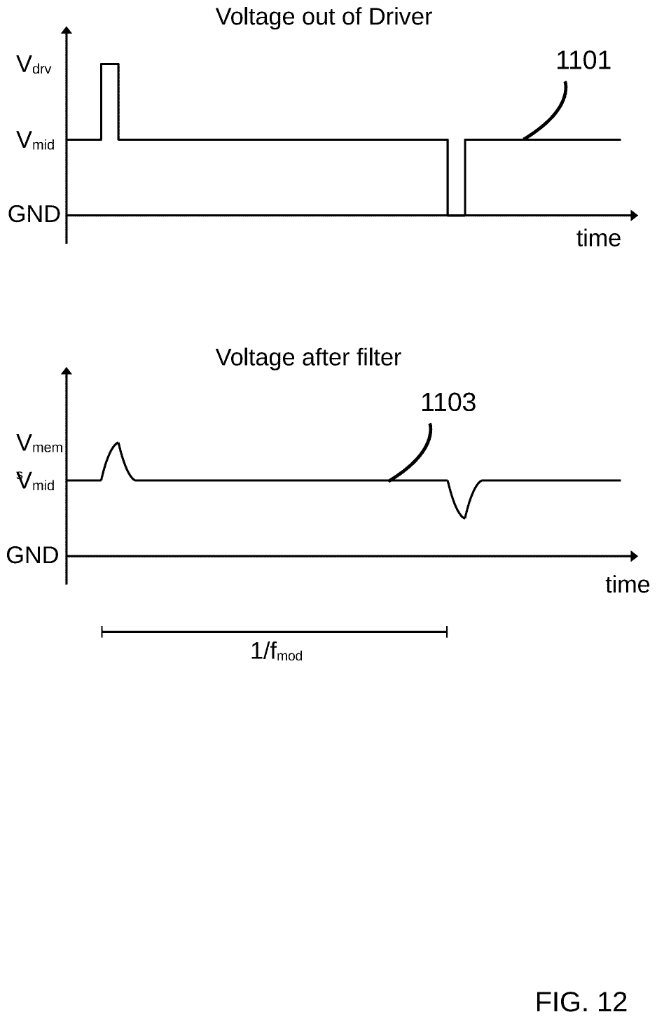

FIG. 12 is an example of a comparison between the voltage from the driver and the voltage after the filter. The Voltage out of the driver (1101) shifts when a small (idle) signal is present. Without a filter this is also the voltage on the MEMS. In the signal after the filter (1103) the voltage on the MEMS is reduced. The actual voltage on the MEMS depends on the pulse width. If the minimum pulse is 64^{th} of

$$\frac{1}{{f}_{mod}}$$

the voltage would be reduced with 36 dB (fₚᵤₗₛₑ=64*f_{mod}=2⁶*f_{mod} Equals 6 octaves, and in a first order filter we get 6 db/octave.). The current needed to change the MEMS voltage is proportional to the voltage change (Vₘₑₘₛ). Since this current is consumed from driver supply in both cases, the power consumption is proportional to the voltage change on the MEMS. Hence, we get roughly 36 dB power savings driving the MEMS with the filter when we have small amplitudes of the signal before the pulse width modulation.

To sum we describe in one example a driver device for operating a modulated ultrasound speaker wherein the ultrasound speaker includes one or more membranes and or modulators, and the driver device comprising of; one or more voltage drivers each configured to provide a voltage signal to one or more membranes and or modulators; a controller; wherein the controller is configured to receive an audio signal, generate a digital signal at a sample rate corresponding to twice the carrier frequency, convert the digital signal to a N bit, noise shaped signal; modulate the N bit noise shaped signal by a carrier frequency and drive a N bit PWM source to operate one or more voltage drivers. In a further example the voltage drivers in include a low pass filter. In a further example a voltage driver includes at least a resistor which combined with the membrane capacitance provides a low pass filter. In a further example the controller is any of but not limited to; a microprocessor; a FPGA; a DSP; an ASIC digital block or any combination of these. In a further example the audio signal is any of but not limited to; a digital signal; a PDM signal; a PWM signal; a I2S signal; an analog signal. In a further example the audio signal is a digital single bit signal with data rates up to any of but not limited to; 1 MHz; 2 MHZ; 3 MHz; 4 MHz; 5 MHz; 6 MHz; 13 MHz; 25 MHz. In a further example the carrier frequency is any of but not limited to; between 200 KHz to 600 KHz; between 600 KHz to 1 MHz; above 1 MHz. In a further example the clock circuit is configured to generate a clock signal using an external reference clock signal. In a further example the clock circuit configured to generate a clock signal using the digital data as a reference clock signal. In a further example the ultrasound speaker includes one or more membranes and or modulators, and the driver device comprised of, a charge pump with one or more voltage levels; one or more voltage drivers each configured to provide a voltage signal to one or more membranes and or modulators; controller; wherein the controller is configured to receive an audio signal, generate a digital signal at a sample rate corresponding to twice the carrier frequency, convert the digital signal to a N bit, noise shaped signal; modulate the N bit noise shaped signal by a carrier frequency and drive a N bit PWM source to operate one or more voltage drivers. In a further example the voltage drivers in include a low pass filter. In a further example a voltage driver includes at least a resistor which combined with the membrane capacitance provides a low pass filter. In a further example the controller is any of but not limited to; a microprocessor; a FPGA; a DSP; an ASIC digital block or any combination of these. In a further example the audio signal is any of but not limited to; a digital signal; a PDM signal; a PWM signal; a I2S signal; an analog signal. In a further example the audio signal is a digital single bit signal with data rates up to any of but not limited to; 1 MHz; 2 MHz; 3 MHz; 4 MHz; 5 MHz; 6 MHz; 13 MHz; 25 MHz. In a further example the carrier frequency is any of but not limited to; between 200 KHz to 600 KHz; between 600 KHz to 1 MHz; above 1 MHz. In a further example the clock circuit is configured to generate a clock signal using an external reference clock signal the clock circuit is configured to generate a clock signal using the digital data as a reference clock signal.

There is little distinction left between hardware and software implementations of aspects of systems; the use of hardware or software is generally (but not always, in that in certain contexts the choice between hardware and software can become significant) a design choice representing cost versus efficiency trade-offs. There are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the signal bearing medium used to carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to disclosures containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”. Speaker and picospeaker are interchangeable and can be used in in place of the other.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A driver device for operating a modulated ultrasound speaker wherein the ultrasound speaker includes one or more membranes and or modulators, and the driver device comprising:
one or more voltage drivers each configured to provide a voltage signal to one or more membranes and or modulators; and
a controller;
wherein the controller is configured to receive an audio signal, generate a digital signal at a sample rate corresponding to twice the carrier frequency, convert the digital signal to a N bit, noise shaped signal; modulate the N bit noise shaped signal by a carrier frequency and drive a N bit PWM source to operate one or more voltage drivers.

2. The driver device of claim 1 wherein a voltage driver includes a low pass filter.

3. The driver device of claim 1 wherein a voltage driver includes at least a resistor which combined with the membrane capacitance provides a low pass filter.

4. The driver device of claim 1 wherein the controller is any of but not limited to; a microprocessor; a FPGA; a DSP; an ASIC digital block or any combination of these.

5. The driver device of claim 1 wherein the audio signal is any of but not limited to; a digital signal; a PDM signal; a PWM signal; a I2S signal; an analog signal.

6. The driver device of claim 1 wherein the audio signal is a digital single bit signal with data rates up to any of but not limited to; 1 MHz; 2 MHz; 3 MHz; 4 MHz; 5 MHz; 6 MHz; 13 MHz; 25 MHz.

7. The driver device of claim 1 wherein the carrier frequency is any of but not limited to; between 200 KHz to 600 KHz; between 600 KHz to 1 MHz; above 1 MHz.

8. The driver device of claim 1 further including a clock circuit configured to generate a clock signal using an external reference clock signal.

9. The driver device of claim 1 further including a clock circuit configured to generate a clock signal using the digital data as a reference clock signal.

10. A driver device for operating a modulated ultrasound speaker wherein the ultrasound speaker includes one or more membranes and or modulators, and the driver device comprising:
a charge pump with one or more voltage levels;
one or more voltage drivers each configured to provide a voltage signal to one or more membranes and or modulators; and
a controller;
wherein the controller is configured to receive an audio signal, generate a digital signal at a sample rate corresponding to twice the carrier frequency, convert the digital signal to a N bit, noise shaped signal; modulate the N bit noise shaped signal by a carrier frequency and drive a N bit PWM source to operate one or more voltage drivers.

11. The driver device of claim 10 wherein the voltage drivers include a low pass filter.

12. The driver device of claim 10 wherein a voltage driver includes at least a resistor which combined with the membrane capacitance provides a low pass filter.

13. The driver device of claim 10 wherein the controller is any of but not limited to; a microprocessor; a FPGA; a DSP; an ASIC digital block or any combination of these.

14. The driver device of claim 10 wherein the audio signal is any of but not limited to; a digital signal; a PDM signal; a PWM signal; a 12S signal; an analog signal.

15. The driver device of claim 10 wherein the audio signal is a digital single bit signal with data rates up to any of but not limited to; 1 MHz; 2 MHz; 3 MHz; 4 MHz; 5 MHz; 6 MHz; 13 MHz; 25 MHz.

16. The driver device of claim 10 wherein the carrier frequency is any of but not limited to; between 200 KHz to 600 KHz; between 600 KHz to 1 MHz; above 1 MHz.

17. The driver device of claim 10 further including a clock circuit configured to generate a clock signal using an external reference clock signal.

18. The driver device of claim 10 further including a clock circuit configured to generate a clock signal using the digital data as a reference clock signal.
